(19) United States
(12) Patent Application Publication
(10) Pub. No.: US 2023/0193649 A1
(43) Pub. Date: Jun. 22, 2023

(54) SHELTER ASSEMBLY

(71) Applicant: NICKOLAS WILLIAM TSENTIDIS, ELIZABETH EAST (AU)

(72) Inventor: NICKOLAS WILLIAM TSENTIDIS, ELIZABETH EAST (AU)

(21) Appl. No.: 17/926,239

(22) PCT Filed: Jun. 15, 2021
(86) PCT No.: PCT/AU2021/050616

§ 371 Date: Nov. 18, 2022

(30) Foreign Application Priority Data
Jun. 16, 2020 (AU) 2020901991

(51) Int. Cl. E04H 15/06; E04H 15/46

(52) U.S. Cl. CPC E04H 15/06; E04H 15/46

(57) ABSTRACT

A shelter assembly is disclosed. In at least one embodiment, the shelter assembly comprises a support assembly configured transitionable from a stowed condition to a deployed condition for providing support to a cover. The support assembly comprises a first part that is configured so as to be operable for transitioning from a stowed condition to or toward an extended condition in which the first part extends substantially across the region. The shelter assembly further comprises a second part that is configured so as to be operable for transitioning from a stowed condition to be operable the first part for providing support to the cover. The cover is configured so as to be operable, by way of the transitioning of the second part, for transitioning from a collapsed condition so as to be supported by the support assembly in the deployed condition.

### FIELD OF THE INVENTION

In one aspect, a shelter assembly for use with a mobile platform or similar is disclosed. In another aspect, a shelter assembly for use with a vehicle is disclosed.

### BACKGROUND

Globally, camping has become a popular pastime enjoyed by persons across a broad spectrum of ages. The increase in the popularity of camping has seen increases in the sales of camper vehicles, due largely to the ease of setup once at a desired destination. This is in comparison to, for example, the effort (strength/dexterity) and investment in time required to assemble a tent shelter (being less appealing to elderly retirees, for example). Camper vehicles, however, can involve significant cost (as compared tents) in terms of initial outlay and regular maintenance and are therefore unaffordable to many aspects of the market.

Some regions (in Australia, for example) providing off-road trails place restrictions on the types of vehicles that are able to travel down them (on the basis that some vehicles can have a tendency to get bogged and or cause damage to the road surface). As such, large camper vehicles may be prohibited from accessing certain regions of interest.

Many tents that fit onto vehicles, or fold from the roof of vehicles take considerable time to erect. This is the last thing that weary travellers need when they've been travelling for long periods of time, and want to rest. Also, in the event of an approaching storm, the need to quickly stow away tents is a helpful option. Hence there is a need for a tent which can be erected quickly, and packed up quickly too.

Accordingly, it is posited that there exists a need/market for a solution that seeks to provide a balance to the above considerations. It is therefore against this general background that the embodiments described herein have been developed.

### SUMMARY OF THE INVENTION

According to a first principal aspect, there is provided a shelter assembly for covering a region of a mobile platform, the shelter assembly comprising:

a support assembly configured transitionable from a stowed condition to a deployed condition for providing support to a cover,

the support assembly comprising:

a first part configured so as to be operable for transitioning from a stowed condition to or toward an extended condition in which the first part extends substantially across the region,

a second part configured so as to be operable for transitioning from a stowed condition so as to be operable with the first part for providing support to the cover,

the cover configured operable, by way of the transitioning of the second part, for transitioning from a collapsed condition so as to be supported by the support assembly in the deployed condition.

According to a second principal aspect, there is provided a shelter assembly for covering

a region of a mobile platform, the shelter assembly comprising:

a support assembly configured transitionable from a stowed condition to a deployed condition for providing support to a cover,

the support assembly comprising:

a first part configured so as to be operable for transitioning from a stowed condition to or toward an extended condition in which the first part extends substantially across the region,

a second part configured so as to be operable with the first part for transitioning from a stowed condition so as to be operable with the first part for providing support to the cover,

the cover is configured operable with the second part so as to be moveable along a path defined by at least a portion of the first part for transitioning the cover from a collapsed condition so as to be supported by the support assembly in the deployed condition.

The above described principal aspects, and those described below, may comprise or incorporate any of the following features, either separately or in combination.

In an embodiment, the cover is configured operable so as to be moveable along a path defined by at least a portion of the first part for transitioning the cover from the collapsed condition to the deployed condition.

The mobile platform may be a movable platform such as for example, a vehicle, a towable body such as a trailer, or a floatable body or vessel such as for example a dinghy, boat, or raft. In this regard, the skilled reader will appreciate that embodiments of the shelter assembly could be used (including by way of any adaptation, configuration, or modification) on many different types of vehicles, trailers, vessels, or movable platforms.

In one embodiment, the shelter assembly may be mounted with a portion of a support structure provided with the mobile platform. In one form, for example, said portion of the support structure comprises a sport bar assembly of a vehicle such as, for example, a utility vehicle (often referred to as a ‘ute’).

In one embodiment, said region covered by the shelter assembly is an open region, such as for example, a tray region of a utility (or ute) vehicle.

In one embodiment, one or more portions of the support assembly (whether by way of the first or second parts, or a respective portion or constituent elements/components thereof) is releasably connectable to a respective portion(s) of the mobile platform so as to secure the support assembly in its deployed condition.

In one embodiment, the first part of the support assembly comprises more than one support frame assemblies, each configured so as to be transitionable between respective stowed and extended conditions.

In one embodiment, each of the support frame assemblies are mounted at or near respective ends thereof with a body (hereinafter, mountable body) so as to be supported by the mountable body. In one form, the mountable body is mounted to a portion of the mobile platform (for example, a sports bar assembly of a utility (ute) vehicle).

In one embodiment, the mountable body is mounted or connected with said portion of the mobile platform at or near an edge of said region. In one form, for example, the mountable body is mounted or connected with a portion of a utility vehicle at or near an edge of a tray region of the utility vehicle.

In one embodiment, the shelter assembly may be operable from within an interior region provided with a sports or roll bar assembly that is mounted to a utility vehicle at or near an edge of the tray region of said vehicle. Said interior region of the utility vehicle may be configured so as to be selectively open/closable.

In one embodiment, the first part of the support assembly comprises first and second support frame assemblies mounted at or near respective ends thereof with the mountable body and arranged in spaced relation relative one another.

In one embodiment, mounting of the first, second support frame assemblies is at or near opposing or opposite ends of the mountable body.

In one embodiment, mounting of the first, second support frame assemblies with the mountable body is by way of a respective bracket or mount assembly (hereinafter, mount assembly).

In one embodiment, the spaced arrangement of the mounting of the first, second support frame assemblies is substantially transverse to a longitudinal axis of the mobile platform.

In one embodiment, the spacing of the first, second support frame assemblies is within the dimension of the mobile platform.

In one embodiment, the longitudinal axis of the mobile platform is substantially aligned with a longitudinal axis of the shelter assembly when deployed.

In one form, the first, second support frame assemblies comprise respective mount assemblies configured for mounting the relevant support frame assembly to or with the mountable body.

In one embodiment, a first portion of each mount assembly is configured so as to be connectable with a respective portion of the mountable body, and a second portion of each mount assembly is configured for connecting with respective portions of respective first, second support frame assemblies such that each is spaced from a portion of the mountable body, said spacing configured so as to provide sufficient room for accommodating the second part of the support assembly (for example, for stowage purposes), or one or more constituent elements thereof.

In one embodiment, each mount assembly is configured so as to enable respective first, second support frame assemblies to be articulable or rotatable (such as for example, by way of a hinge arrangement) relative to the mountable body. In one embodiment, such articulation/rotation is enabled substantially in the vertical plane.

In one embodiment, each of the first, second support frame assemblies is arranged so as to be mounted with a first portion of the mountable body in a manner in which the respective first, second support frame assemblies are spaced from a second portion of the mountable body so as to provide sufficient room for accommodating the second part of the support assembly, or one or more constituent elements thereof.

For example, an end (or portion/region near same) of each of the first, second support frame assemblies may be mounted with the first portion of the mountable body so as to extend away from same in spaced relation (thereby, for example, allowing sufficient space for accommodating the second part of the support assembly, or one or more constituent elements thereof) from the second portion of the mountable body (for example, in a cantilevered like manner). In this manner, the first and second portions of the mountable body may be aligned so as to be orthogonal to one another. In one embodiment, the first portion of the mountable body is a substantially vertically aligned wall of said body, and the second portion of the mountable body is a base of the same aligned substantially in the horizontal plane. An advantage of such a cantilevered arrangement is that more space can be provided for accommodating the second part.

In one embodiment, the first and second support frame assemblies of the first part are each formed by way of respective assemblies of a plurality of constituent elements, which respective assemblies of constituent elements are configured or arranged operable so as to enable the respective first, second support frame assemblies to be transitionable from respective stowed conditions (representing the stowed condition of the first part) to the extended condition of the first part.

In one embodiment, the or each constituent element(s) of the first part may comprise an elongate member capable of conferring a supportive function. For example, the or each constituent element(s) of the first part may be provided in the form of a finite length support element or support member. Such support elements/members may be referred to as arm sections, or segments. In one sense, one which draws from human anatomy, such sections or segments are configured so as to provide each of the first, second support frame assemblies in the form of respective ‘spine’ arrangements or assemblies. Thus, each of the first and second support frame assemblies analogy a respective spine arrangement or assembly operable for providing support for the constituent elements of the second part of the support assembly and which collectively provides support to the cover, or ‘skin’, of the shelter assembly. In this manner, the first and second support frame assemblies may operate as spine arrangements or assemblies for providing a ‘backbone’ of the support assembly.

In one embodiment, when transitioned to the extended condition, the first, second support frame assemblies of the first part are aligned in a spaced apart and substantially parallel manner.

In one embodiment, when transitioned to the extended condition, respective assemblies of the constituent elements of the first, second support frame assemblies are in an aligned relation substantially in accordance with their respective longitudinal axes.

In one embodiment, each of the first, second support frame assemblies are, at or near a respective first free end, mounted with the mountable body. In one embodiment, each of the first, second support frame assemblies are, at or near a respective second free end, configured so as to be releasably associable with a portion of the mobile platform for securing the first part in its extended condition. In one form, said releasable association of the first, second support frame assemblies with said portion of the mobile platform is by way of one or more constituent element(s) of the second part.

In one embodiment, each of the first, second support frame assemblies by way of the assembly of their respective constituent elements are configured so as to vary the effective or projected length of the first part between the stowed and extended conditions. In one embodiment, such extension of the effective or projected length of the first part is enabled by way of a telescopic relationship between one or more sets of adjacent constituent elements.

In one embodiment, at least one constituent element of each of the first, second support frame assemblies is arranged in telescopic relation with an adjacently disposed constituent element.

In one embodiment, each of the first, second support frame assemblies by way of the assembly of their respective constituent elements is configured so as to provide one or more articulable joint arrangements capable of articulation in one or more planes.

In one embodiment, each of the first, second support frame assemblies by way of the assembly of their respective constituent elements is configured so as to provide: one or more articulable joint arrangements capable of enabling articulation (for example, rotation) of one of said constituent elements relative to a constituent element adjacent thereto substantially in either of the horizontal or vertical planes, and or one or more constituent elements arranged in telescopic relation with an adjacent constituent element for facilitating extension of the effective or projected length of the first part.

In one embodiment, the first and second support frame assemblies are each configured for enabling relative rotation between adjacent constituent elements to occur in substantially the horizontal plane by way of a hinge arrangement for providing one of said articulable joint arrangements.

In one embodiment, the first and second support frame assemblies are each configured for enabling relative rotation between adjacent constituent elements to occur in substantially the vertical plane by way of a hinge assembly for providing one of said articulable joint arrangements.

In one embodiment, the first and second support frame assemblies are each configured for enabling both relative rotation between adjacent constituent elements to occur in substantially the horizontal plane by way of a first hinge arrangement for providing a first articulable joint arrangement, and relative rotation between adjacent constituent elements to occur in substantially the vertical plane by way of a second hinge arrangement for providing a second articulable joint arrangement.

In one embodiment, the or each articulable joint arrangement is configured so as to enable relative rotation between adjacent constituent elements about more than one axis of rotation. In one embodiment, at least two of said more than one axes of rotation may be substantially orthogonal to one another.

In one embodiment, the or each articulable joint arrangement is configured so as to enable relative rotation between adjacent constituent elements about first and second axes of rotation, whereby said first and second axes are aligned substantially orthogonal to one another. In one form, such articulable joint arrangement is provided in the form of a swivel joint arrangement.

In one embodiment, one or more of said hinge or articulable joint arrangement(s) are configured so as to be moveable or translatable within an associated constituent element of the first, second support frame assemblies.

In one embodiment, the or each of said hinge or articulable joint arrangement(s) are configured so as to be capable of engaging with one or more portions of an associated constituent element by way of a magnetic association therewith for releasably securing a portion of said hinge or articulable joint arrangement with the relevant associated constituent element.

In one embodiment, adjacent constituent elements arranged in a telescopic relation with each other are configured so as to attain in a state of telescopic extension by way of a portion of one of the adjacent constituent elements configured so as to engage with a portion of the other of the adjacent constituents elements. In this manner, once said state of telescopic extension is attained, further relative extension is prevented. In one form, prevention of said further relative extension seeks to prevent disengagement between said adjacent constituent elements.

In one embodiment, adjacent constituent elements arranged in telescopic relation with each other are configured so as to be releasably confirmed in a state of telescopic extension by way of a magnetic association between a portion of one of the adjacent constituent elements with a portion of the other of the adjacent constituents elements. In one embodiment, respective portions of said adjacent constituent elements that cooperate to attain said state of telescopic extension are configured in magnetic relation thereby operating to releasably confirm said adjacent constituent elements in said state of telescopic extension.

In one form, any of said constituent elements of the first, second support frame assemblies are provided in the form of support elements of tubular or rod-like form of finite length.

In one embodiment, one or more support elements are configured so as to be operable in a telescopic manner with an adjacent support element so as to be operable between a retracted condition and an extended condition, thereby enabling respective first, second support frame assemblies to be extendable so as to increase the effective or projected length of the first part.

In one embodiment, each of the first, second support frame assemblies of the first part comprise respective first and second support elements arranged in operable association with one another.

In one embodiment, each first support element is mounted, at or near an end thereof, with a portion of the mountable body (either directly or via a respective mount assembly) so that the respective first, second support frame assemblies are spaced from one another in supported relation with the mountable body.

In one embodiment, each second support element of the first, second support frame assemblies is arranged in hinged relation with the respective first support element so that the second support element is rotatable from a stowed condition (of the first part) toward the extended condition (of the first part) in which longitudinal axes of the first and second elements are substantially aligned with one another. In one form, an angle through which the second support element may rotate relative to the first support element is about 90 degrees to/from the stowed condition. In one form, the second support element rotates relative to the first support element in a substantially horizontal plane. In this manner, for example, the second support elements of each of the first, second support frame assemblies are operable so as to be foldable toward/away from each other when transitioning to/from the stowed condition.

In one embodiment, unfolding of the second support element of each of the first, second support frame assemblies from the stowed condition operates to extend the effective or projected length of the first part along the longitudinal axis of the shelter assembly.

In one embodiment, rotation of each second support element relative to the respective first support element is facilitated by a hinge arrangement. In one form, the hinge arrangement comprises a shaft or pin passed through and residing in apertures provided in interfacing portions of the first, second support elements.

In one embodiment, the second support element of each of the first, second support frame assemblies is configured in telescopic relation with a respective third support element, the operation of which serves to assist in the transition of the first part of the support assembly from the stowed condition to the extended condition.

In one embodiment, the third support element of each first, second support frame assembly is configured so as to be in sliding engagement with its respective second support element such that the third support element is moveable from a first relative condition, where the relevant third support element is housed substantially within its respective (host) second support element, to or toward a second relative condition, where the relevant third support element protrudes a distance outward from its respective (host) second support element, thereby operating to extend the effective or projected length of the first part in a telescopic like manner. In one embodiment, the third support element is arranged with the second support element so as to be slidably moveable inside of the respective second support element. Alternatively, the third support element is arranged with the second support element so as to be slidably moveable outside of the respective second support element.

In one embodiment, each third support element may be arranged in telescopic relation with one or more further support element(s) in substantially the same manner as described above. In this manner, use of the or each further support element serves to increase the effective length of the first, second support frame assemblies in/along the longitudinal axis of the shelter assembly.

In one embodiment, the third support elements of each of the first, second support frame assemblies are each configured so as to be operable with a respective fourth support element. Operability between the third and fourth support elements may be by way of telescopic relation, and or relative rotation therebetween (by way of, for example, connection therebetween via at least one articulable joint arrangement).

In one embodiment, the operable nature of the assembly of the constituent elements which form respective first, second support frame assemblies serves to define, at least in part, a portion of the path for guiding movement of one or more constituent elements of the second part of the support assembly. In one embodiment, said path, or a portion thereof, may be linear or curvilinear in form. The profile or form of the path may be influenced by the form of one or more of the relevant constituent elements, which form is informed by way of, for example, respective lengths, cross-section geometry, fabrication material and the like).

In one embodiment, any of the constituent elements or support elements forming the first, second support frame assemblies possess increased rigidity or stiffness (for example, bending stiffness) as compared one or more of the other constituent elements or support elements. For example, first and second support elements of each of the first, second support frame assemblies may possess increased stiffness or rigidity than that of respective third (fourth or more) support elements, or which respective third (fourth or more) support elements may be formed so as to be more flexible relative to one or both first and second support elements of respective first, second support frame assemblies. In this manner, the third (fourth or more) support elements may be configured so as to be more susceptible to forces causing deflection or bending in their respective longitudinal axes which serves to define a curved portion along the effective or projected length of respective first, second support frame assemblies. In one embodiment, enabling of such curved portion is operable for, at least in part, tensioning a portion or region of the cover when in the deployed condition or as the cover is being transitioned to or toward the deployed condition.

In one embodiment, a portion at or near respective distal ends of the first, second support frame assemblies is configured so as to be connectable with a portion of the mobile platform for the purposes of releasably securing the first part in its extended condition.

In one embodiment, connection between said portion at or near respective distal ends of the first, second support frame assemblies and respective portion(s) of the mobile platform for the purpose of releasable connection therebetween is by way of a magnetic association.

In one embodiment, the second part of the support assembly comprises a plurality of constituent elements that are configured or arranged operable with the first and second support frame assemblies of the first part for transitioning the second part from its stowed condition so as to be in supported relation with the first part.

In one embodiment, the or each constituent elements of the second part may comprise an elongate member capable of conferring a supportive function. For example, the or each constituent element(s) of the second part may be provided in the form of a finite length support element or support member. Such support elements/members may be referred to as ‘ribs’ or ‘slats’. In one sense, one which draws from human anatomy, such support elements/members are configured so as to provide respective rib(s) which are supported by way of the ‘spine’ arrangements or assemblies formed by the first and second support frame assemblies of the support assembly. In this manner, the first and second support frame assemblies may operate as an overarching spine or ‘backbone’ arrangement of the support assembly for providing support to the ‘ribs’ of the second part, and which, collectively, provide support to the cover, or ‘skin’, of the shelter assembly.

In one embodiment, each constituent element of the second part is aligned substantially transverse (hereinafter, transverse elements) to the longitudinal axis of the mobile platform, whether the first part is in the stowed condition or otherwise.

In one embodiment, each of the transverse elements of the second part are aligned substantially transverse to the extension directions of the first, second support frame assemblies when the first part is in its extended condition.

In one embodiment, the transverse elements are each configured so that opposing or opposite ends thereof are in sliding relation with one or more of the constituent elements which form respective first, second support frame assemblies. In this manner, a transverse element of the second part is configured operable for sliding along portions of respective lengths of one or more of the constituent elements of respective first, second support frame assemblies.

In one embodiment, the opposite or opposing ends of the or each transverse elements are configured or provided with a connecting arrangement configured for enabling supportive movement of said transverse element along a respective length of each of the first, second support frame assemblies of the first part, or portions of one or more constituent elements thereof. In one embodiment, said connecting arrangement carried by opposing ends of the transverse elements comprises a loop, eyelet, collar or similar formation (hereinafter, loop) configured for receiving one or more constituent elements of respective first, second support frame assemblies of the first part for enabling sliding engagement therebetween while in supportive relation with the constituent elements of the first, second frame assemblies. In this manner, movement of the or each transverse element is, in part, guided by a path defined by the first, second support frame assemblies.

In one embodiment, a plurality of the transverse elements are arranged or configured so as to be spaced along the first, second support frame assemblies of the first part when in the extended condition.

In one embodiment, the transverse elements are each of rod or tubular form of finite length.

In one embodiment, one or more transverse elements of the second part are connected with the cover. In one embodiment, each of the transverse elements of the second part are connected with the cover at spaced locations thereacross.

In one embodiment, at least one transverse element of the second part is configured operable so as to be handled for assisting in moving of the second part, and or the cover, relative to the first part. Such handling may be by way of a handle portion provided with the relevant transverse element, for example.

In one embodiment, a stop assembly is provided at or near a respective terminal end of the first, second support frame assemblies, the stop assembly being configured operable for engaging or interacting with the loop of a transverse element as it is moved (for example, via sliding engagement) along the first, second support frame assemblies in the transition of the first part to its extended condition. In this manner, the engagement or interaction between the stop assembly with one or both respective loops of the relevant transverse element operates to prevent (further) movement of the transverse element relative to the relevant terminal end of the first, second support frame assemblies thereby preventing disengagement therefrom.

In one embodiment, the handle portion is operable by a user for the purpose of applying a force (for example, a pulling force) thereto so as to move the first part toward its extended condition (for example, by a user).

In one embodiment, for the case where the first, second support assemblies each comprise one or more constituent elements configured in telescopic relation, telescopic extension of the first part can be operated by moving a transverse element so that one of both of its respective loops engages with a stop assembly provided at or near an end of a telescopically operable constituent element, movement of the transverse element once engaged with the catch or stop thereby causing telescopic extension of the first part.

In one embodiment, one or more transverse elements of the second part are configured so as to be extendable in a substantially telescopic manner. In one form, the or each transverse element may be formed or assembled having more than one constituent parts configured such that at least one of said parts is moveable relative (eg. either internal or external of) to another of said parts.

In one embodiment, a transverse element of the second part is configured so as to be telescopic for enabling variation in a length of said transverse element. In one embodiment, said telescopic transverse element is configured operable for use in assisting in releasable securement of the support assembly with a portion of the mobile platform to which the shelter assembly is arranged operable with.

In one embodiment, the cover is operable with the second part for the purpose of transitioning from the collapsed condition to the deployed condition.

In one embodiment, the collapsed condition of the cover corresponds with the stowed condition of the support assembly.

In one embodiment, the cover transitions from the collapsed condition to or toward the deployed condition by way of being caused to follow movement of one or more transverse elements along a portion of the extended lengths of the first, second support frame assemblies, or a portion of the path defined by the first part.

In one embodiment, one of the transverse elements is operable for assisting in the releasable securement of the first part in its extended condition relative a portion of the mobile platform. Such releasable securement may be achieved by a portion of the relevant transverse element engaging with a portion of the mobile platform. In other arrangements, such releasable securement may be achieved using a form of fastening arrangement, such as for example, a nut/bolt fastening arrangement, a catch or stop arrangement, a magnetic arrangement. The skilled reader would appreciate that any form of fastening arrangement could be used to, broadly, secure the first part in a releasable manner with a portion of the mobile platform.

In one embodiment, releasable securement of the first part in its extended condition with the mobile platform via one of the transverse elements is by way of said transverse element engaging with a catch provided with the mobile platform (the catch being applied to or an inherent component of the mobile platform).

In one embodiment, releasable securement of the first part in its extended condition is by way of one or more constituents of the second part being configured so as to, on engagement or interaction with a respective portion of the mobile platform, operate to assist in retaining said constituents of the second part sufficiently for holding the first part in its extended condition. In one form, such engagement may be by way of magnetic association.

In one embodiment, the cover is configured so as to provide, when in the deployed condition, an upper portion, one or more side portions, and one or more end portions. In one embodiment, the configuration of the cover is arranged so as to reduce regions where the cover is open to local surrounds when deployed.

In one embodiment, any of the upper, side portions, or end portions are configured so as to comprise one or more window or access regions. For example, any of such window or access regions may be formed by way of operation of one or more zipper assemblies or similar.

In one embodiment, one or more edge(s) of the cover (or portions thereof) are provided with attachment means for allowing a respective edge to be releasably securable with or against a portion of the mobile platform, so as to facilitate releasable securement of the cover with portions of the mobile platform. The skilled reader will appreciate that any appropriate attachment means may be used/employed.

In one embodiment, one or more adjustable tensioning systems or assemblies may be configured operable with any portion of region of the cover (for example, edges) and portions of the mobile platform for tensioning the cover. In this manner, the presence or occurrence of prospective hollow regions forming in or about the cover can be reduced or managed.

In one embodiment, the dimensioning of the cover and or any of the components of the first, second support frame assemblies is configured so that, when the support assembly is in the deployed condition, the cover is sufficiently tensioned so as to reduce the presence of hollow regions which could result in, for example, the pooling of rain water, dew, or moisture.

In one embodiment, the cover is provided or formed so as to be foldable or pliant to allow for ease of movement when transitioning between its collapsed condition and when supported by the support assembly in the deployed condition.

In one embodiment, the cover is formed from a sufficiently flexible or pliant material so as to be capable of transitioning to/from its stowed condition.

In one embodiment, the cover is a tarpaulin and or comprises weather proof material/substance/coating.

In one embodiment, the shelter assembly comprises an enclosure configured for accommodating the shelter assembly when in the stowed condition. In various arrangements, the enclosure is mounted with or to a support structure (for example, a portion of a chassis, roll cage/bar assembly, cab, or sports bar assembly of a vehicle).

In one embodiment, the enclosure is formed of a combination of a soft/flexible and rigid/hard material.

In one embodiment, the enclosure is configured so as to provide a region in which the first, second parts, and cover can be stowed, a portion of the enclosure configured so as to serve as a selectively operable closure.

In one form, selective operation of the closure is by way of a zipper assembly.

In one embodiment, the mountable body forms a portion of the enclosure.

In one embodiment, a portion of the mountable body provides a base of the enclosure upon which the mount assemblies are mounted in spaced relation so as to support respective ends (or portions near said ends) of the first, second support frame assemblies.

In alternative embodiment, a portion of the mountable body provides a vertically aligned wall of the enclosure arranged in orthogonal relation to the base, wherein respective ends of the first, second support frame assemblies of the first part are mounted to the wall in spaced apart relation with each other and configured so as to extend away from the wall in a cantilevered like manner across and spaced from the base.

In one embodiment, the spacing between at or near the ends of the first, second support frame assemblies (regardless of whether supported by way of a respective mount assembly or mounted to the wall in a cantilevered like manner, or otherwise) and the base allows for sufficient clearance so as to accommodate the transverse elements of the second part when in the stowed condition.

In one embodiment, a first articulable joint of each of the first, second support frame assemblies does not extend beyond a profile or envelope defined by the base of the enclosure.

According to a third principal aspect, there is provided a tent arrangement adapted for deployment on a vehicle, or ute tray and tailgate, comprising:

at least two substantially parallel support members,

at least two ribs substantially perpendicular to and supported by the support members to guide movement of each rib relative to the support members,

a cover supportable by the ribs and moveable between an extended in-use position and a retracted or stowed position, and

a fastener that releasably connects the cover to the vehicle.

Embodiments of the third principal aspect may comprise or incorporate any of the features described in relation to the first or second principal aspects, or as otherwise described herein, either separately or in combination.

In embodiments of the present aspect, which draw analogy from human anatomy, each of the spines echo the first and second support frame assemblies of the first part of the above described principal aspects, and which operate for providing support for the ribs (which echo the transverse elements of the second part) for, collectively, providing support to the cover, or ‘skin’, of the tent arrangement.

According to a fourth principal aspect, there is provided a method for forming a shelter assembly for covering a region of a mobile platform, the method comprising:

configuring a support assembly so as to be operable for being transitionable from a stowed condition to a deployed condition for providing support to a cover, the support assembly comprising:

a first part configured so as to be operable for transitioning from a stowed condition to or toward an extended condition in which the first part extends substantially across the region,

a second part configured so as to be operable for transitioning from a stowed condition so as to be operable with the first part for providing support to the cover,

configuring the cover so as to be operable, by way of the transitioning of the second part, for transitioning from a collapsed condition so as to be supported by the support assembly in the deployed condition.

According to a fifth principal aspect, there is provided a method for forming a shelter assembly for covering a region of a mobile platform, the method comprising:

configuring a support assembly so as to be operable for being transitionable from a stowed condition to a deployed condition for providing support to a cover, the support assembly comprising:

a first part configured so as to be operable for transitioning from a stowed condition to or toward an extended condition in which the first part extends substantially across the region,

a second part configured so as to be operable with the first part for transitioning from a stowed condition so as to be operable with the first part for providing support to the cover,

configuring the cover so as to be operable with the second part so as to be moveable along a path defined by at least a portion of the first part for transitioning the cover from a collapsed condition so as to be supported by the support assembly in the deployed condition.

According to a further principal aspect, there is provided a method for forming a shelter assembly for covering a region of a mobile platform, the method comprising: operating a first part so as to transition from a stowed condition to an extended condition in which the first part extends substantially across the region, operating a second part so as to transition from a stowed condition so as to be operable with the first part for providing support to the cover, transitioning the cover, by way of the transitioning of the second part, from a collapsed condition so as to be supported by the support assembly in a deployed condition.

According to a further principal aspect, the shelter assembly as described herein is configured operable as a temporary shelter or a quick-pitch shelter for a mobile platform.

According to a further principal aspect, there is provided a mobile platform comprising any embodiment of the shelter assembly as described herein.

According to another principal aspect, there is provided a sport or roll bar assembly of or configured for attachment with a vehicle, the sport or roll bar assembly (by way of an appropriate modification or otherwise) configured having a portion thereof for housing any embodiment of the shelter assembly as described herein, and from which the shelter assembly is transitionable to/from a stowed condition.

According to another principal aspect, there is provided a method of using any embodiment of the shelter assembly as described herein.

According to another principal aspect, there is provided a method of operably configuring any embodiment of the shelter assembly as described herein.

According to another principal aspect, there is provided a method of operably configuring a shelter assembly for use with a mobile platform, the shelter assembly being formed or configured so as to exemplify any embodiment of the shelter assembly as described herein.

According to another principal aspect, there is provided a tent arrangement or tent assembly comprising any embodiment of a shelter assembly as described herein. It will be understood that related methods for forming, using, or operably configuring such tent arrangements or tent assemblies may be substantially similar to any of the methods described herein that involve any embodiment of the shelter assembly as described herein.

According to another principal aspect, there is provided a method of operably configuring a mobile platform, or portion thereof, for use with any embodiment of the shelter assembly as described herein.

According to another principal aspect, there is provided a method of operably configuring a vehicle, or portion thereof, for use with any embodiment of the shelter assembly as described herein.

According to a further principal aspect, there is provided a cover for use with any embodiment of a shelter assembly as described herein. In one embodiment said cover is formed so as exemplify any embodiment of a cover as described herein. In one embodiment, the cover is formed of appropriate material or fabric so as to be foldable for allowing for movement between stowed and deployed conditions. In one embodiment, the cover comprises a material or fabric from which a tarpaulin may be formed. In one embodiment, the cover comprises weather proof material.

Various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples, or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

It is to be understood that each document, reference, patent application or patent cited in this text is expressly incorporated herein in their entirety by reference, which means that it should be read and considered by the reader as part of this text. That the document, reference, patent application, or patent cited in this text is not repeated herein is merely for reasons of conciseness.

Furthermore, in this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive concept/principles is/are exemplified.

### BRIEF DESCRIPTION OF THE DRAWINGS

Further features of the inventive principles are more fully described in the following description of several non-limiting embodiments thereof. This description is included solely for the purposes of exemplifying the inventive principles. It should not be understood as a restriction on the broad summary, disclosure or description as set out above. The description will be made with reference to the accompanying drawings in which:

FIG. 1 shows a perspective view of one embodiment of a shelter assembly operable with a utility vehicle arranged in accordance with the principles described herein;

FIG. 2 shows a perspective view of one embodiment of an enclosure configured for housing the shelter assembly when in a stowed condition;

FIG. 3 shows a further perspective view of the shelter assembly shown in FIG. 1, in a non-deployed condition (with the vehicle and cover removed);

FIG. 4 shows a perspective view of another embodiment of the shelter assembly arranged in accordance with the principles described herein;

FIG. 5 shows a further perspective view of the embodiment shown in FIG. 4;

FIG. 6 shows a further perspective view of the embodiment shown in FIG. 5 (showing support assembly only);

FIG. 7 shows the internal detail of the connection between the support members of the support assembly;

FIG. 8 shows a side view of the connection between the cross member and the substantially vertical spine at the end of the shelter assembly;

FIGS. 9A to 9D show a deployment progression of the shelter assembly from a semi deployed state to a deployed state; and

FIG. 10 shows a side view of the vehicle with cover securement and adjustment means.

In the Figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted in order to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the particular arrangements of the embodiment(s) as well as of the particular applications of such embodiment(s).

Specifically, reference to positional descriptions, such as ‘lower’ and ‘upper’, and associated forms such as ‘uppermost’ and ‘lowermost’, are to be taken in context of the embodiments shown in the Figures and are not to be taken as limiting the scope of the principles described herein to the literal interpretation of the term, but rather as would be understood by the skilled reader.

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION

The words used in the specification are words of description rather than limitation, and it is to be understood that various changes may be made without departing from the spirit and scope of any aspect of the invention. Those skilled in the art will readily appreciate that a wide variety of modifications, alterations, and combinations can be made with respect to the above described embodiments without departing from the spirit and scope of any aspect of the invention, and that such modifications, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

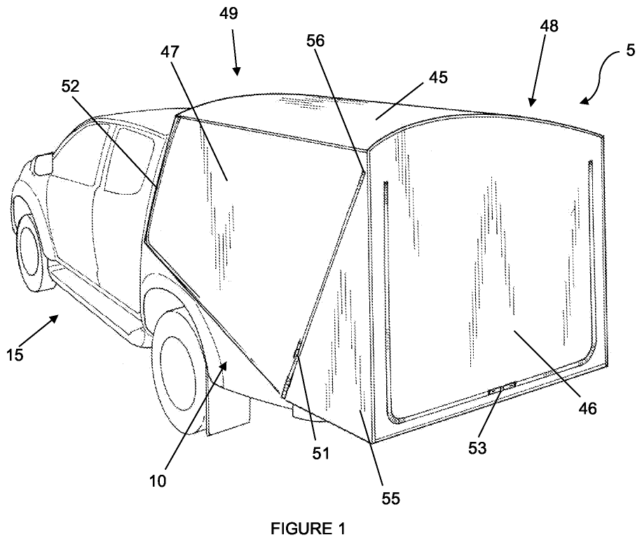

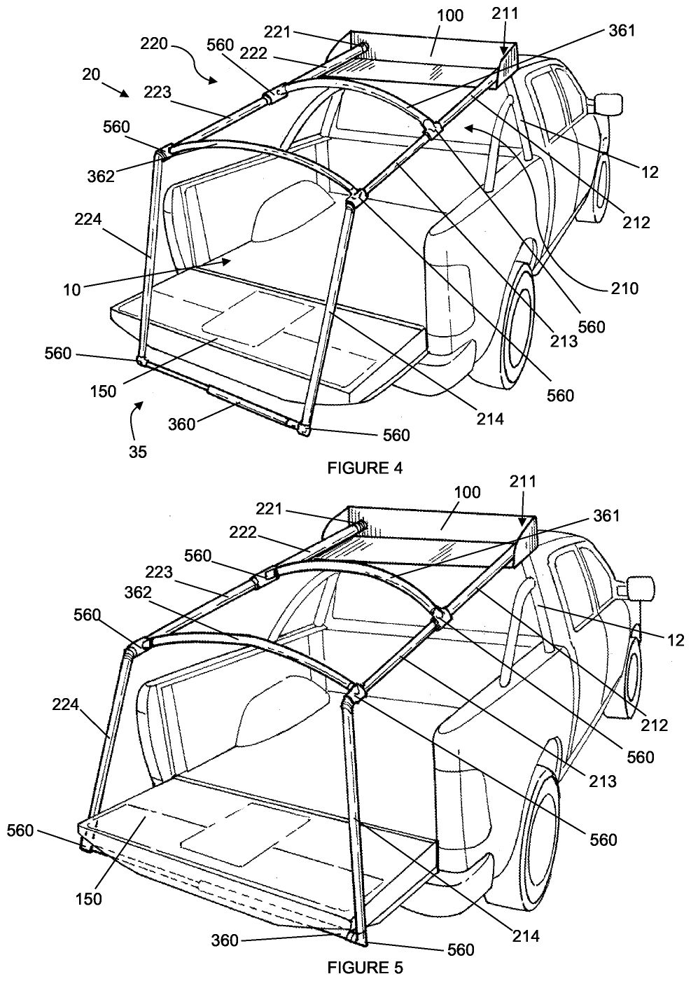

FIG. 1 shows an embodiment of a deployed shelter assembly 5 arranged in accordance with the principles described herein, mounted atop a roll bar 12 also known as a sports bar (as seen in FIGS. 4 and 5) which is located adjacent a forward edge of a tray region 10 of a utility vehicle 15 (usually referred to as a ‘ute’ or ‘pick up’ truck). Broadly speaking, the shelter assembly 5 comprises a first part 20 and second part 35 for providing a structural frame to support a cover 45 such that when covered, defines a shelter within the region of the cover and a portion of the tray region 10 of the utility vehicle 15. The first part 20 comprises support frame assemblies (discussed below) which extend substantially the length of the region to be covered by the cover 45. The second part 35 comprises support members which engage with the first part 20 to impart additional stability and strength to the first part 20 and additional support for the cover 45. Each of the first part 20 and second part 35 will be discussed in turn below.

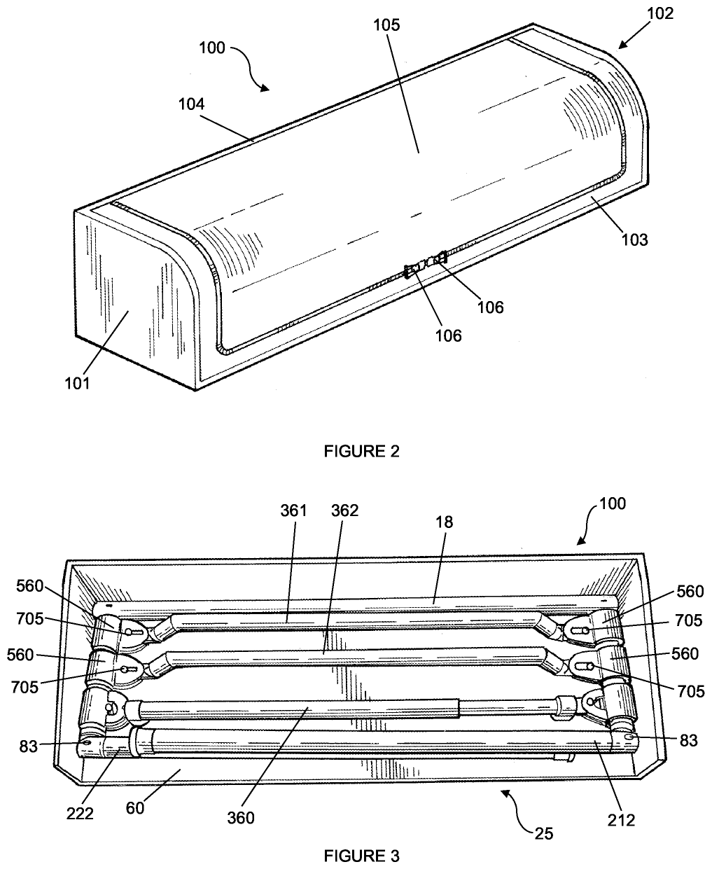

Referring to FIG. 2, an enclosure 100 may host a closure portion 105 in a manner which allows the closure to be selectively openable. The closure portion 105 may be of a flexible material that is operable by way of a zipper fastening system 106 so that the closure portion 105 can be rolled or furled for allowing access to the interior of the enclosure 100. The closure portion 105 may also comprise one or more strips of hook and loop fastener either instead of a zipper fastening system 106 or incorporated in combination with zipper fastening system 106. The skilled reader will readily appreciate many different arrangements/configurations for providing an appropriate enclosure without departing from the principles described herein.

With respect to FIG. 2, the enclosure 100 is formed of rigid material comprising side walls 101 (left hand side), 102 (right hand side), forward most wall 104, portion 103 which provides an upper facing side which transitions rearward for providing a rear facing side, the enclosure 100 configured so as to enclose, envelop or encapsulate the shelter assembly 5 therein when in the stowed condition 25 so as to be safely protected (from surrounding environs) when the shelter assembly 5 is not in use (such as for example, when the vehicle is moving). Preferably, the enclosure 100 and closure portion 105 comprise a weatherproof material or a weatherproof coating.

With respect to FIG. 3, the shelter assembly 5 is mounted to a base 60 which is itself preferably mounted to the sports bar 12 of the utility vehicle 15 (as seen in FIGS. 4 and 5). The first part 20 of the support assembly comprises first and second support frame assemblies 210, 220 which are mounted to a portion of the enclosure 100, such as the base 60, in spaced relation with one another. Each of the first support frame assembly 210 and the second support frame assembly 220 may be mounted to a longitudinally extending cross member 18. The cross member 18 may be rotatably mounted to the enclosure 100 at the sides 101 and 102 or to the base 60. The cross member 18 may allow for rotation of the first and second support frame assemblies 210, 220 about a central axis of cross member 18. Rotation of the cross member so as to pivot the horizontal support members 211, 221 and associated generally upward so as to be able to increase the height of the shelter assembly 5 at an end opposite the enclosure 100.

As mentioned above and shown in FIGS. 4 and 5, the enclosure 100 is mounted/supported atop the sports bar 12 of the vehicle 15. In this arrangement, the sports bar 12 is forward of, and spaced vertically from, an edge of a floor of the tray region 10 of the vehicle 15. In this manner, when the shelter assembly 5 is operated to deploy the cover 45, a substantial portion of the floor of the tray region 10 is covered thereby providing a substantial volume protected/sheltered by way of the cover 45.

For deployment, with vehicle 15 is parked, the zipper assembly 106 of the enclosure 100 is opened (by rolling/furling the closure portion 105) so as to allow access to the shelter assembly 5. The cover 45 is unfolded so as to drape a front portion 49 of the cover 45 over the forward wall 104 of the enclosure 100 (so as to extend between the sports bar 12 and the rear wall of the cabin of the vehicle 15). Once done, each of the left hand side portion 47 and right hand side portion 48 of the cover 45 are draped over respective sides 101, 102 of the enclosure 100 so as to extend/hang toward the lower region of the vehicle 15. The portions of the cover 45 are fastened together by a plurality of zipper assemblies 51, 52 (the right hand side of cover 45 (not shown) has zipper assemblies which mirror zipper assemblies 51 and 52 as seen on the left hand side of cover 45 in FIG. 1).

The cover 45 comprises a back end 55 which is flexible or pivotable about an end 56 of zipper assembly 51 such that the back end 55 can articulate independently in an arc like motion relative to the remainder of the cover 45. The back end 55 may comprise a pocket (not shown) extending across the width of the back portion end 55 for receiving therein a tailgate 150 or tray region 10 of a utility vehicle 15. Following articulation or manipulation of the back end 55 so as to receive the tailgate 150 or tray region 10 within the pocket, back end 55 is fastened to the side portions 47, 48 of the cover 45 by operation of each of respective zipper assembly 51 and the rear right hand side zipper assembly (not shown). Once fastened, the cover 45 is held taut to define the walls, roof and entryway of the shelter assembly covering the region by the cover 45. Unfastening and retraction of cover portion 46 provides an entryway into and out of the internal region of the shelter assembly 5. The rear cover portion 46, left hand portion 47 and right hand portion 48 may further comprise sub portions which may be unfastened and retracted so as to provide a window similar to a standard tent window. The assembling of the support structure is discussed below.

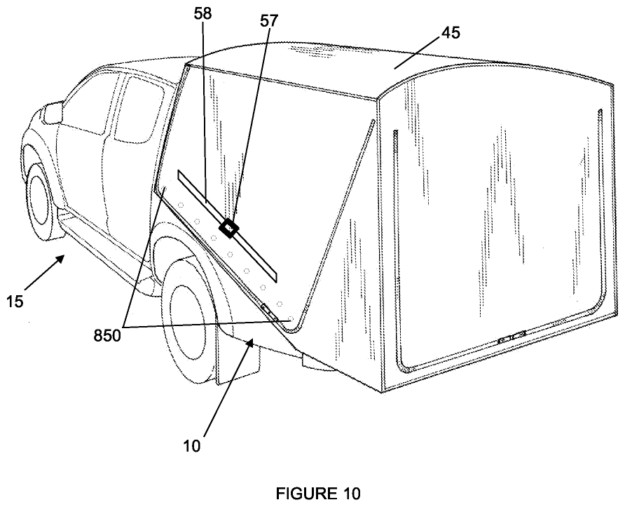

The final stages of deployment involve securement of various portions/regions of the cover 45 so as to sufficiently tension the fabric about the first 20 and second 35 parts and the vehicle's 15 body. In some embodiments (like that shown in FIG. 10), a plurality of magnetic elements 850 may be used to releasably attach a lower edge of the middle portion 47 of the cover 45 to an area of the vehicle adjacent to the rear wheel arch. These features would preferably be mirrored on the side not shown in FIG. 10.

In an alternative embodiment, the cover 45 may have a plurality of resiliently stretchable (‘bungee’) loops affixed at lower edges of the portions to be secured. The tray region 15 or other portion of the utility vehicle may have a plurality of buttons or hooks affixed thereto which receive a portion of a respective bungee loop so as to apply constant tension to an edge of the cover 45. The or each button is generally circular in shape and has a channel revolved about a central axis such that the channel contours to fit the shape of the bungee loop. Accordingly, to affix the portion of the cover 45, a user would place the cover in position and then each bungee loop is stretched towards and around a respective button.

Various edge(s) of the cover 45 are provided with means for allowing portions thereof (such as, for example, edge regions/portions) to be releasably secured to various portions of the vehicle 15 when the cover 45 is in the deployed condition (as seen in FIG. 1) so as to confer sufficient securement there between. Referring to FIG. 10, again, such means may comprise adjustable straps 58 configured so that the tension in the straps 58 can be varied as required. The or each strap 58 is fed through a buckle member 57. The buckle member 57 can slide relative to the cover 45 and in doing so causes a portion of the strap 58 to overlap and shorten or lengthen a portion of the cover 45. In this manner, the cover 45 can be appropriately secured about the support assembly and the various portions of the vehicle 15 as required in order to confer an appropriate tension within the cover 45 so as to reduce catenary in the cover 45 or portions of the cover 45. The person skilled in the art would appreciate that there are a number of ways to releasably affix and adjust the fit of the cover to the shelter assembly without departing from the general inventive concept.

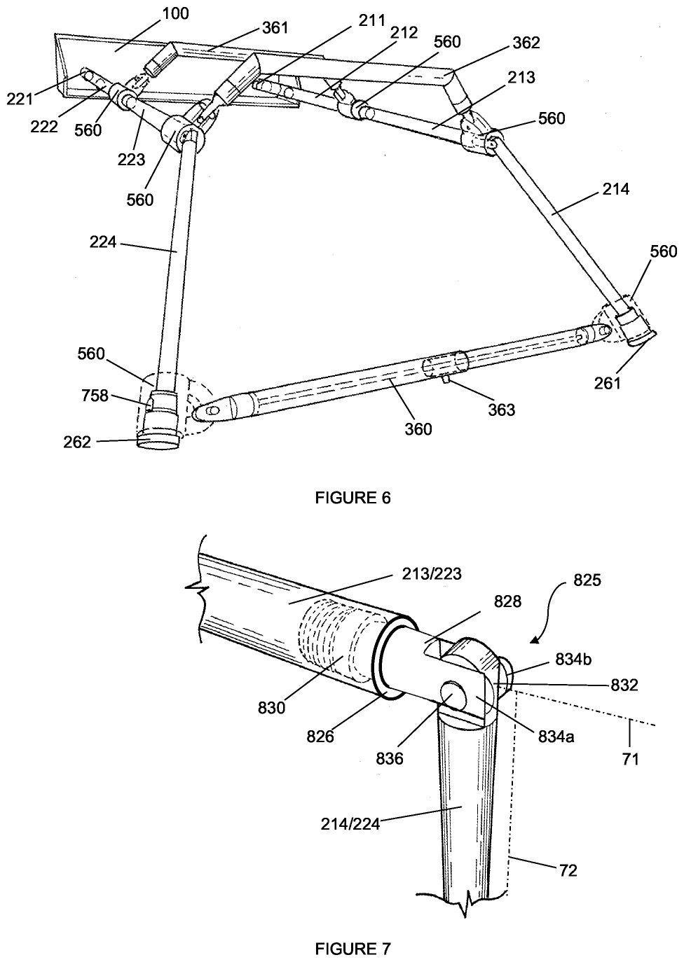

Referring to FIGS. 3 and 6 generally, the first support frame assembly 210 and second support frame assembly 220 each comprise a plurality of support members, preferably provided in respective telescopic arrangements. In the present embodiment, the first support frame assembly 210 comprises first support member 211, second support member 212, third support member 213 and fourth support member 214 (collectively referred to as first support frame assembly 210. In the present embodiment, the second support frame assembly 220, mirroring the first support frame assembly 210, comprises first support member 221, second support member 222, third support member 223 and fourth support member 224 (collectively referred to as second support frame assembly 220). Two or more of the support members are preferably provided in a telescopic arrangement. For example, in the present embodiment, support members 212, 213, 214 of the first support frame assembly 210 are provided in a telescopic arrangement. In addition, in the present embodiment, support members 222, 223, 224 of the second support frame assembly 220 are provided in a telescopic arrangement. In alternative embodiments, more or less support members may be provided in a telescopic arrangement without departing from the inventive concept. While various terminology may be used to describe each of the support members that comprise the first and second support frame assemblies 210, 220 of the first part 20, such support members may be referred to as arm sections or segments.

In another sense, such sections or segments are configured so as to provide each of the first and second support frame assemblies 210, 220 in the form of respective spine arrangements or assemblies. Thus, each of the first and second support frame assemblies 210, 220 analogy respective spine arrangements or assemblies which are operable for providing support for the constituent elements (for example, ‘ribs’ or ‘slats’ (360, 361, 362)) of the second part 35 of the support assembly and which, collectively, provide support to the cover 45, or ‘skin’, of the shelter assembly 5. In this manner, the first and second support frame assemblies 210, 220 operate as spine arrangements for providing a ‘backbone’ of the support assembly.

The second support members 212, 222 of the respective first and second support frame assemblies 210, 220 of the first part 20 further are each operably associated with the respective first support members 211, 221 at their respective ends. Each of the second support members 212, 222 are preferably of tubular form having a circular cross section extending uniformly along their respective (elongate) lengths. In alternative embodiments, the cross section of the support members may be square or another shape.

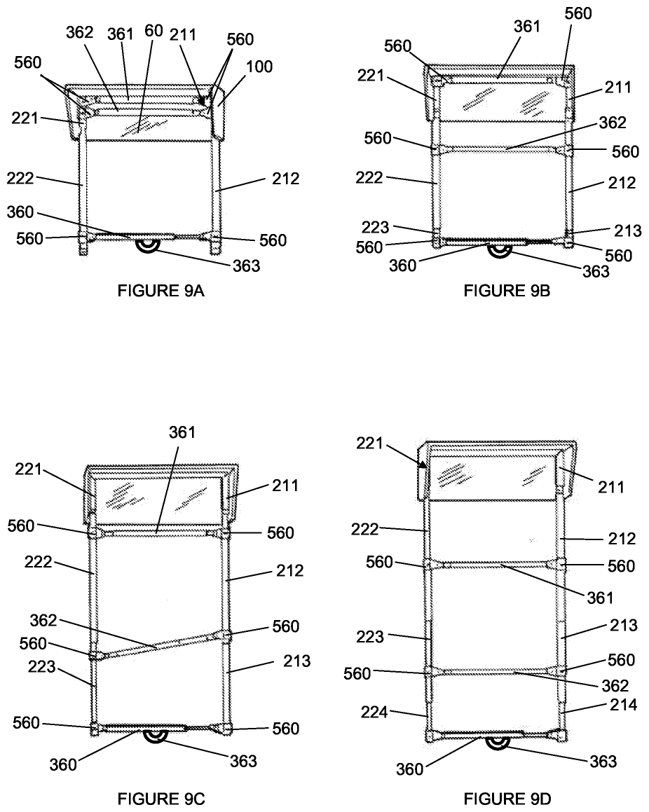

Each second support member 212, 222 is rotatably connected by way of a hinge arrangement at respective ends thereof with respective ends of respective first support members 211, 221 support members so as to be rotatable from/to a first relative position in which both second support members reside substantially in the stowed condition 25, and generally parallel each other as shown in FIG. 3. In this manner, the second support members 212, 222 are rotatable toward each other for folding toward the stowed condition 25, and rotatable outward from the stowed condition 25 to or toward an unfolded condition (shown in FIG. 9A) by way of respective rotation enabled via respective hinge arrangements 83. As shown in FIGS. 9A to 9D, when arranged in the unfolded and extended condition the second support members 212, 222 are generally parallel with each other in spaced relation. With regard to FIG. 3, the hinge arrangements 83 between the second support members 212, 222 and respective ends of respective first support members 211, 221 is arranged so that each second support member 212, 222 rotates or swings substantially in the horizontal plane. Each second support member 212, 222 comprises respective distal ends that, as a consequence of the rotation (which is generally through an angle of about 90 degrees) swing so as to each align generally parallel with the longitudinal axis of the region being covered. In this manner, conclusion of the rotation event results in longitudinal axes of the respective second support member 212 (and respective telescopically retracted support members 213, 214) of the first support assembly 210 and second support member 222 (and telescopically retracted support members 223 and 224) of the second support assembly 220 being in substantial axial alignment with the respective longitudinal axes of associated first support members 211, 221, as shown in FIG. 9A.

As noted above, rotation of respective second support members 212, 222 relative to respective first support members 211, 221 is by way of respective hinge arrangements 83, each comprising a pin element inserted through apertures provided in the respective interfacing ends of the first support members 211, 221 and second support members 212, 222. Each hinge arrangement 83 is configured so that transverse support members 360, 361, 362 of the second part 35 are able to transition from being supported at their respective opposite terminal ends along the first support members 211, 221, and the second support members 212, 222 (and, indeed, any additional support elements of respective first and second support frame assemblies 210, 220). One or more of the transverse support members 360, 361, 362 may be formed concavely towards the internal region so as to define a larger region within the first and second support frame assemblies 210, 220. The skilled reader would appreciate that other hinge arrangements could be possible that enable the required relative rotation.

FIGS. 3 and 6 show further detail of the collar arrangements 560 supporting and slidably connecting opposite ends of each of the transverse supported members 360, 361, 362 with the relevant support members of respective support frame assemblies 210, 220. With reference first to FIG. 3 (showing the collar arrangements 560 connecting each end of the transverse support members 360, 361, 362 with the support frame assemblies 210, 220, more specifically in the stowed condition 25 to the first support members 211, 221), the collar arrangement 560 is configured so as to provide a hinge or pivot point between the end of the transverse support members 361, 362 and the support frame assemblies 210, 220. FIG. 9C (discussed in detail below) shows the collar arrangement 560 in relation to the support frame assemblies 210, 220 during deployment of the shelter assembly 5. Transverse support members 361, 362 comprise a pin and slot connection 705 (seen in FIG. 3) which operate to provide a pivotable connecting joint so as to allow easier translation of transverse support members 361, 362. The connecting joint provides additional movement to assist in preventing seizing of the collar arrangements 560 on one or more of the respective support members of support frame assemblies 210, 220 during deployment/stowing of transverse support members 361, 362. Without the pin and slot connection 705 the collar arrangements 560 would require the ends of each transverse support member 361, 362 to translate along the length of each support frame assembly 210, 220 at substantially the same rate to prevent jamming of the transverse support members 361, 362. In such an instance, jamming could occur when the collar arrangements 560 become misaligned from the longitudinal axis of each support frame assembly 210, 220 due to rigid connection between a respective collar arrangement 560 and the support member which it is sliding over.

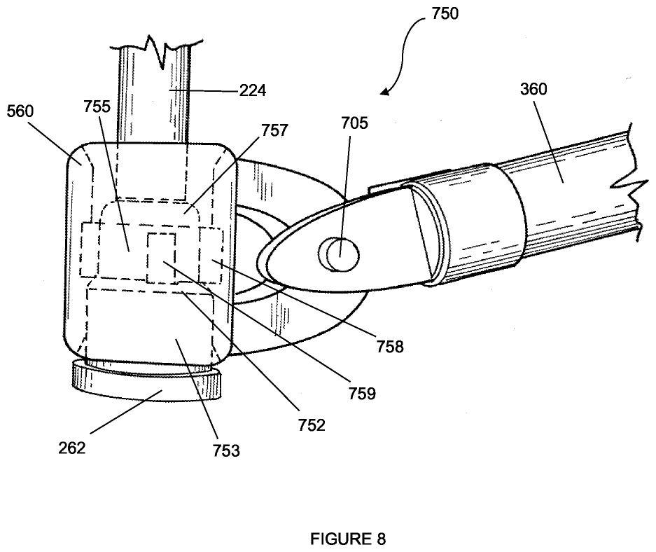

FIG. 9C shows the movement allowed by the pin and slot connection 705 of the collar arrangement 560 which allows translation when each end of the transverse support members 361, 362 travel at different rates along each of the support frame assemblies 210, 220. Preferably, it is a pin and slot connection 705. However, the connection may be only a pivotable connection, such as the connection between the transverse support member 360 and respective collar arrangements 560 at each end, as seen in FIG. 8. As transverse support member 360 is to restrain support members 214, 224 in a particular orientation, having a slot orientation is not preferable. A pin and slot connection 705 may be used in collar arrangements 560 associated with transverse support member 360 provided the slot is sufficiently limited to reduce lateral motion.

Referring to FIG. 7, the connection between the third support members 213, 223 and respective fourth support members 214, 224 is preferably by way of a universal joint or swivel arrangement 825 which telescopically slides/translates within the tubular hollow of the third support member 213, 223 but also allows the fourth support members 214, 224 to rotate about two axes: a first axis 71 aligned with the longitudinal axis of the third support member 213, 223, and a second axis 72 aligned substantially orthogonal with the first axis 71. In this way, distal ends of each of the fourth support members 214, 224 can be moved away from each other along the width dimension of a tailgate 150 or tray region 10 of the utility vehicle 15, as shown in FIGS. 4 and 5. The increase in spatial distance between the respective distal ends of each of the fourth support members 214, 224 serves a practical advantage in being able to allow the distal ends of both said support members sufficient spacing to fit the size and shape of the tailgate 150 so that the transverse support member 360 can hold support members 214, 224 in a position and place to support the cover 45. For example, each of the support members 214, 224 comprise a rubber foot 261, 262 (seen in FIGS. 6 and 8) at respective distal ends of the support members 214, 224 which may rest on a respective corner of tailgate 150.

To accommodate this increase in spatial distance between the distal ends of the fourth support members 214, 224, the transverse support member 360 itself is configured so as to be capable of telescopic extension/retraction. The transverse support member 360 may also comprise a retractable pin 363 to lock transverse support member 360 at a desired spatial distance so as to provide additional stability/support to the first part 20 and prevent splaying of the support members 214, 224, relative to each other. The initial phase of the telescopic operation involves moving each of the fourth support members 214, 224 toward the distal extent of the vehicle's tailgate 150. During movement of support member 214, 224, the transverse support member 360 is caused to extend telescopically to an appropriate length (in the width dimension of the tailgate 150 or tray region 10) for allowing ends of both fourth support members 214, 224 to conform to the respective sides of the tailgate 150 or tray region 10 as shown in the transition between FIGS. 4 and 5. The transverse support member 360 can then locate adjacent to the underside of the tailgate 150 in a desired manner. For example, the transverse support member 360 may simply seat and be sufficiently captured/retained within an open style extrusion or lip part of the tailgate assembly or be retained in position with the assistance of the snug fit of a tailgate pocket of cover 45. Alternatively, and as mentioned above, the distal ends of fourth support members 214, 224 may comprise rubber feet 261, 262 which rest on the furthest corners of the tailgate 150 or tray region 10 and held from extending further by the fit of the cover 45. The skilled reader would appreciate various ways in which the transverse support member 360 could be releasably retained in position with the tailgate assembly 150.

FIG. 7 also shows the distal end of the third support members 213, 223 is provided with an annular or ring shaped lip portion 826 sized so as to allow movement of a rod portion 828 axially within the third support member 213, 223 and to project through a central aperture of the annular lip portion 826 for hinged connection with an end of the respective fourth support member 214, 224. Thus, respective rod portions 828 are moveable internally of respective third support members 213, 223 and rotatable about the first axis 71.

FIG. 7 further shows the hinging arrangement between the rod portions 828 and respective fourth support members 214, 224 is by way of a projecting element 832 extending from an end of the fourth support member 214, 224 so as to reside between extending arm portions 834a, 834b provided by the rod portion 828. Alignment between the projecting element 832 and the extending arm portions 834a, 834b is arranged so that respective apertures formed in each of the projecting element 832 and arm portions 834a, 834b receive and accommodate a pin element 836 that is retained in position and substantially orthogonal with the axis of respective third support members 213, 223 about which the fourth support members 214, 224 have freedom to rotate. In this manner, the configuration of the translatable swivel joint 825 enables each of the fourth support members 214, 224 to be capable of rotation about both first and second axes described above, while also being axially translatable within respective third support members 213, 223.

FIG. 7 shows a schematic view of the interior of the end of the third support members 213, 223, about the rod portion 828, and the interior of the third support members 213, 223, sits an annular or ring-shaped magnet 830. In operation, telescopic extension of the fourth support members 214, 224 relative to respective third support members 213, 223 ceases when the annular shaped magnet 830 abuts against the annular lip portion 826. Thus, the annular shaped magnet 830 serves as a stop arrangement preventing the fourth support members 214, 224 from disengaging from respective third support members 213, 223. Magnetic association between the annular shaped magnet 830 and the annular lip portion 826, once both are brought into contact, results in the rod portion 828 being (releasably) secured in position. Of course, release of the securement can be achieved by disrupting the magnetic association. The strength of the magnetic association can be selected depending on the retaining force needed.

With reference to FIG. 8, the lock arrangement 750 is shown in perspective view. The lock arrangement 750 comprises a body 752 that releasably attaches to distal ends of respective fourth support members 214, 224. Translatable along the first and second support assemblies 210, 220 is the collar arrangement 560. The body of the lock arrangement 750 comprises a base 753 at one end which transitions (in a taper or step like manner) to a smaller exterior diameter dimension for defining a middle region 755, which then transitions in a tapering or beveled like manner (identified as 757) toward the distal end of the fourth support member 214, 224. The middle region 755 provides an annular recess 754 (relative to the base 753) configured about its exterior surface for accommodating one or more biasing elements 759. Each of the biasing elements 759 are attached or integrated into the exterior surface of the annular recess 755 (near an end of same), and each having distal ends which are biased away from the exterior surface of the recess 755. Each of said biasing elements 759 are formed or shaped from material having sufficient resilience so as to confer a biasing or spring like function.

With further reference to FIG. 8, the collar arrangement 560 shows an internal annular recess or groove 758 which can align with the or each biasing mechanism 759 so as to be biased away from the exterior surface of the recess 755 and lock the collar arrangement 560 with respect to the fourth support member 214, 224 when in a deployed condition as can be seen in FIG. 6. During retraction of the first and second support frame assemblies 210, 220 to a stowed condition 25, the or each biasing mechanism 759 is configured to engage with an edge of the internal wall of the third support members 213, 223 and retract to a position within the inner diameter of the third support member 213, 223. Alternatively, the body may be removed from the distal ends of the fourth support members 214, 224 and then installed during deployment. The body 752 may comprise mechanical means for mechanically retracting the or each biasing mechanism 759 so as to release the collar arrangement 560 from a locked condition (shown in FIG. 8).

Referring to FIGS. 9A to 9D there is generally provided an example of the staged transition of each of the first and second support frame assemblies 210, 220 and transverse support members 360, 361, 362 following the initial rotation of second support member 211, 221 from the stowed condition 25 (seen in FIG. 3) to the position shown in FIG. 9A. FIGS. 9A to 9D shows the staged extension of the second support members 212, 222, third support members 213, 223, and fourth support members 214, 224 from being telescopically nested with each other, after having been rotated away (via respective hinge arrangements 83) from their stowed condition 25. As seen, each of the transverse support members 361, 362, and 360 of the second part 35 are supported in their stowed condition 25 by the first support member 211,221.

A terminal end of each fourth support member 214, 223 is provided with a respective end stop 261, 262 which is dimensioned/shaped so as to, in a one aspect, prevent the terminal ends retracting completely into its host second and third support members 212, 213, 222, 223. Furthermore, end stops 261, 262 serve to also catch or stop the transverse support member 360 from becoming disengaged from the respective fourth support member 214, 224. Thus, each end stop 261, 262 is configured so as to interfere sufficiently with the collar arrangements 560 for preventing disengagement of the rear (or distal) most transverse support member 360 from the distal ends of the respective fourth support members 214, 224. In this manner, when seeking to deploy the cover 45, a user may do so by handling, or manipulating as required, the rear most transverse support member 360 by moving same away from the second support members 212, 222, when aligned in a parallel manner following their respective rotation away from the stowed condition 25 (seen in FIG. 9A). In this manner, with disengagement prevented by the end stops 261, 262, the user may pull upon the rear most transverse support member 360 thereby serving to pull or drag each of the fourth support members 214, 224 out(ward) from within their respective host second and third support members 212, 213, 222, 223 toward the extended condition. For this purpose, the rear most transverse support member 360 may comprise a handle 363. For any such handling or manipulation, the handle 363 is provided generally centrally of the rear most transverse support member 360 so that pulling of same does not prejudice or bias any end of the transverse support member 360 during the (sliding) motion. Thus, a centrally disposed handle 360 serves to ensure that pulling or dragging of rear most transverse support member 360 provides for a substantially even (or symmetrical) movement of the fourth support members 214, 224 out(ward) from their respective host second and third support members 212, 213, 222, 223. Such motion may also be assisted when operable with collar arrangements 560 which connect opposite ends of the transverse support members 360, 361, 362 with the support elements of the first part 20 using the pin and slot connection arrangement 705.

The method of deploying/stowing the present invention will now be described with reference to the drawings.

After having the enclosure 100 being installed on the sports bar 12 of a utility vehicle 15 the user unzips the enclosure closure portion 105 to uncover the shelter assembly 5 in a stowed condition 25 as seen in FIG. 3. The user then swings out the second support members 212, 222 (having respective third and fourth support members 213, 214, 223, 224 telescopically retracted within) aligning them with the respective first support members 211, 221. Pulling on each of the fourth support members 314, 324 causes the support frame assemblies 210, 220 to telescopically extend over and past the region to be covered. Once extended, the transverse support members 360, 361, 362 can slide by way of their respective collar arrangements 560 along each of the support frame assemblies 210, 220 to a desired position. Transverse member 360 will slide along the support frame assemblies 210, 220 until it locks in place at the distal ends of the fourth support members 214, 224.

In an embodiment where the transverse support member 360 comprises a handle, the user may extend the support frame assemblies 210, 220 by pulling the handle 363 of the transverse support member 360 away from the enclosure 100 thereby causing each of the third and fourth support members 213, 214, 223, 224 to extend from their respective second support member 212, 222 until fully extended as seen in FIG. 9D. The collar arrangements 560 of the transverse support member 360 will lock into the distal ends of the respective fourth support members 214, 224 during extension or when fully extended and the user continues to pull on the handle 363. The remaining transverse support members 361, 362 may slide by way of their respective collar arrangements 560 along the support frame assemblies 210, 220 to a desired position.

Once fully extended, the user may then rotate the fourth support members 214, 224 (by way of the swivel join 825) downward towards the tailgate 150 such that the fourth support members are substantially orthogonal to the other support members. The user may then adjust the transverse support member 360 to adjust the positioning of the distal ends of the fourth support members 214, 224 so as to fit the specific tailgate 150 or tray region 10 of the utility vehicle 15 as seen in FIGS. 4 and 5. In one embodiment, the rubber feet 261, 262 of the fourth support members 214, 224 may rest on the corners of the tailgate 214. In alternative embodiments, the transverse support member 360 and fourth support members 214, 224 may be supported by an edge of the tailgate 150 or otherwise as described herein.

Once the support frame assemblies 210, 224 have been deployed and positioned, the cover 45 is now ready to be installed. The front cover portion 49 is draped over and moved into place between a cab of the utility vehicle 15 and the sports bar 12. The remainder of the cover 45 is unfurled, rolled, or moved into place over the remaining parts of the shelter assembly 5. In particular, back portion of the cover 55 being unzipped may allow additional manipulation of the cover 45 so as to allow the tailgate 150 to be lifted slightly so as to slide into the pocket running parallel with the lower edge of the back cover flap 46 on the back portion of the cover 55. The pocket opens towards the tailgate 150 so as to receive at least a portion of the tailgate 150. Once the tailgate 150 is within the pocket, the zipper 51 and like zipper on right hand side may be actuated from respective end 56 and like end on right hand side along the length of the zipper assembly so as to restrict the back portion of the cover 55 to the remainder of the cover 45. After which, the remaining zipper 52 and similar on the right hand side at the front of the cover 45 can be actuated so as to have the cover 45 generally installed.

After the cover 45 is in place and installed, the edges of the side portions 47, 48 of the cover 45 may be stretched and retained in place by the magnetic elements 850 or bungee loop/button arrangement as described above. Further where there is loose cover 45 or catenary in the cover 45, the straps 58 may be adjusted through buckle member 57 so as to tighten the cover 45.

Stowing of the shelter assembly is completed in the reverse of the above.

It will be appreciated that future patent applications may be filed in Australia or overseas on the basis of, or claiming priority from, the present application.

It is to be understood that the following claims are provided by way of example only and are not intended to limit the scope of what may be claimed in any such future application. Features may be added to or omitted from the provisional claims at a later date so as to further define or redefine the invention or inventions.

1. A shelter assembly for covering a region of a mobile platform, the shelter assembly comprising:
a support assembly configured transitionable from a stowed condition to a deployed condition for providing support to a cover,
the support assembly comprising:
a first part configured so as to be operable for transitioning from a stowed condition to or toward an extended condition in which the first part extends substantially across the region,
a second part configured so as to be operable for transitioning from a stowed condition so as to be operable with the first part for providing support to the cover,
the cover configured operable, by way of the transitioning of the second part, for transitioning from a collapsed condition so as to be supported by the support assembly in the deployed condition.

2. A shelter assembly according to claim 1, wherein the cover is configured operable so as to be moveable along a path defined by at least a portion of the first part for transitioning the cover from the collapsed condition to the deployed condition.

3. A shelter assembly according to claim 1 or 2, wherein the first part of the support assembly comprises first and second support frame assemblies mounted at or near respective ends thereof with a mountable body and arranged in spaced relation relative one another.

4. A shelter assembly according to any one of claims 1 to 3, wherein the second part of the support assembly comprises a plurality of the transverse elements arranged so as to be spaced along the first and second support frame assemblies of the first part when in the extended condition.

5. A shelter assembly according to claim 4, wherein at least one transverse element of the second part is configured operable so as to be handled for assisting in moving of the second part, and or the cover, relative to the first part.

6. A shelter assembly according to any one of claims 3 to 5, wherein a spaced arrangement of the mounting of the first and second support frame assemblies is substantially transverse to a longitudinal axis of the mobile platform.

7. A shelter assembly according to any one of claims 3 to 6, wherein at least one constituent element of each of the first and second support frame assemblies is arranged in telescopic relation with an adjacently disposed constituent element.

8. A shelter assembly according to any one of claims 3 to 7, wherein a portion at or near respective distal ends of the first, second support frame assemblies is configured so as to be connectable with a portion of the mobile platform for the purposes of releasably securing the first part in its extended condition.

9. A shelter assembly according to claim 8, wherein connection between said portion at or near respective distal ends of the first, second support frame assemblies and respective portion(s) of the mobile platform for the purpose of releasable connection therebetween is by way of a magnetic association.

10. A shelter assembly according to any one of claims 1 to 9, wherein one or more edge(s) of the cover (or portions thereof) are provided with attachment means for allowing a respective edge to be releasably securable with or against a portion of the mobile platform, so as to facilitate releasable securement of the cover with portions of the mobile platform.

11. A shelter assembly according to any one of claims 1 to 10, wherein one or more adjustable tensioning systems or assemblies may be configured operable with any portion of region of the cover and portions of the mobile platform for tensioning the cover.

12. A tent arrangement adapted for deployment on a vehicle, or ute tray and tailgate, comprising:
at least two substantially parallel support members,
at least two ribs substantially perpendicular to and supported by the support members to guide movement of each rib relative to the support members,
a cover supportably by the ribs and moveable between an extended in-use position and a retracted or stowed position, and
a fastener that releasably connects the cover to the vehicle.

13. A method for forming a shelter assembly for covering a region of a mobile platform, the method comprising:
operating a first part so as to transition from a stowed condition to an extended condition in which the first part extends substantially across the region,
operating a second part so as to transition from a stowed condition so as to be operable with the first part for providing support to the cover,
transitioning the cover, by way of the transitioning of the second part, from a collapsed condition so as to be supported by the support assembly in a deployed condition.
